(19) United States
(12) Patent Application Publication
(10) Pub. No.: US 2024/0403724 A1
(43) Pub. Date: Dec. 5, 2024

(54) BINARY CLASSIFICATION DEVICE AND METHOD FOR CORRECTING ANNOTATION IN BINARY CLASSIFICATION DEVICE

(71) Applicant: Mitsubishi Electric Corporation, Tokyo (JP)

(72) Inventor: Ryoma YATAKA, Tokyo (JP)

(73) Assignee: Mitsubishi Electric Corporation, Tokyo (JP)

(21) Appl. No.: 18/801,962

(22) Filed: Aug. 13, 2024

Related U.S. Application Data
(63) Continuation of application No. PCT/JP2022/013784, filed on Mar. 24, 2022.

(51) Int. Cl. G06N 20/10

(52) U.S. Cl. CPC G06N 20/10

(57) ABSTRACT

A binary classification device according to the present disclosure technology includes a reliability addition distribution generator to calculate, for each of annotators, a reliability addition histogram regarding a reliability added by the annotator, a bias corrector to correct, by referring to a reference reliability addition distribution, the reliability addition histogram to a corrected reliability addition histogram having the same characteristic as a characteristic of the reference reliability addition distribution, and a corrected reliability output to correct the reliability added by the annotator by referring to the corrected reliability addition histogram.

### CROSS REFERENCE TO RELATED APPLICATION

This application is a Continuation of PCT International Application No. PCT/JP2022/013784, filed on Mar. 24, 2022, which is hereby expressly incorporated by reference into the present application.

### TECHNICAL FIELD

The present disclosure technology relates to a binary classification device and a method for correcting annotation in a binary classification device.

### BACKGROUND ART

The problem handled by the present disclosure technology is a problem of classification in learning, and is particularly a problem called binary classification or two-class classification.

For example, Non Patent Literature 1 poses a problem of how to obtain an identification boundary in a case where only samples belonging to one of two classes are given, and discloses a solution thereof.

### CITATION LIST

### Non Patent Literature

Non Patent Literature 1: Takashi Ishida et al., Binary Classification from Positive-Confidence Data, NeurIPS 2018 (Thirty-second Conference on Neural Information Processing Systems).

### SUMMARY OF INVENTION

### Technical Problem

In a case where a plurality of annotators performs annotation in a shared manner, there is a problem that a training data set obtained by the annotation lacks consistency as a whole due to bias (tendency, inclination, and prejudice) of each of the annotators.

An object of the present disclosure technology is to solve the above problems and to provide a binary classification device capable of performing learning by referring to a training data set having consistency as a whole.

### Solution to Problem

A binary classification device according to the present disclosure technology includes a reliability addition distribution generator to calculate, for each of annotators, a reliability addition histogram regarding a reliability added by the annotator, a bias corrector to correct, by referring to a reference reliability addition distribution, the reliability addition histogram to a corrected reliability addition histogram having the same characteristic as a characteristic of the reference reliability addition distribution, and a corrected reliability output to correct the reliability added by the annotator by referring to the corrected reliability addition histogram.

### Advantageous Effects of Invention

With the above configuration, a binary classification device according to the present disclosure technology can perform learning by referring to a training data set in which a bias of an annotator is corrected.

### BRIEF DESCRIPTION OF DRAWINGS

FIG. 1 is a diagram No. 1 illustrating a concept of binary classification performed by a binary classification device according to the present disclosure technology.

FIG. 2 is a diagram No. 2 illustrating a concept of binary classification performed by the binary classification device according to the present disclosure technology.

FIG. 3 is a diagram No. 3 illustrating a concept of binary classification performed by the binary classification device according to the present disclosure technology.

FIG. 4 illustrates an example in which biases of annotators are modeled by a statistical distribution of reliability added by annotators.

FIG. 5 is a block diagram illustrating a functional configuration of the binary classification device according to a first embodiment.

FIG. 6 is a diagram illustrating a state in which a bias of an annotator is corrected by referring to a reference reliability addition distribution.

FIG. 7 is a flowchart illustrating processing steps of the binary classification device according to the first embodiment.

FIG. 8 is a block diagram illustrating a hardware configuration of the binary classification device according to the first embodiment.

### DESCRIPTION OF EMBODIMENTS

A binary classification device according to the present disclosure technology can be used in a scene where an event that is difficult to objectively score is learned and scored by artificial intelligence. More specifically, the present disclosure technology can be used when generating a training data set necessary for learning of artificial intelligence. The present disclosure technology is particularly effective in a scene where annotation is performed by sharing a training data set by a large number of annotators.

A scene assumed by the present disclosure technology is, for example, work in which an operator drops and deletes a portion determined to be a false track by the operator in a plan position indicator scope (PPI) of a radar.

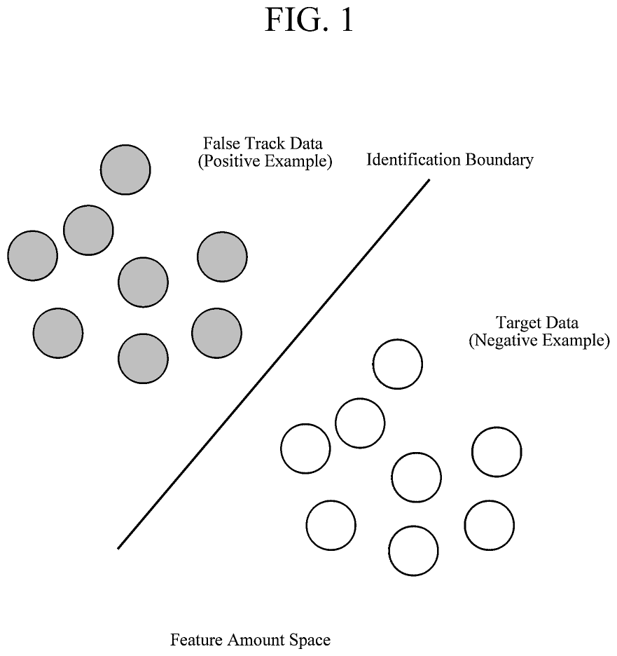

FIG. 1 is a diagram No. 1 illustrating a concept of binary classification performed by the binary classification device according to the present disclosure technology. As illustrated in FIG. 1, the problem handled by the present disclosure technology is a classification problem in learning, and in particular, the problem handles two exclusive classes. The term “exclusive” as used herein means that samples belonging to two classes at the same time are not permitted. In the example illustrated in FIG. 1, a group displayed as “false track data (positive example)” and a group displayed as “target data (negative example)” are two classes. In FIG. 1, the “positive example” is displayed in the “false track data” because a scene is assumed in which the operator drops a location corresponding to a false track.

FIG. 1 illustrates a feature amount space as a whole. Plural plots indicated by circles in FIG. 1 are samples in a feature amount space.

A line segment depicted with a display of “identification boundary” in FIG. 1 is a solution to the classification problem in learning. As a method of obtaining a solution of a classification problem, for example, a support vector machine is known.

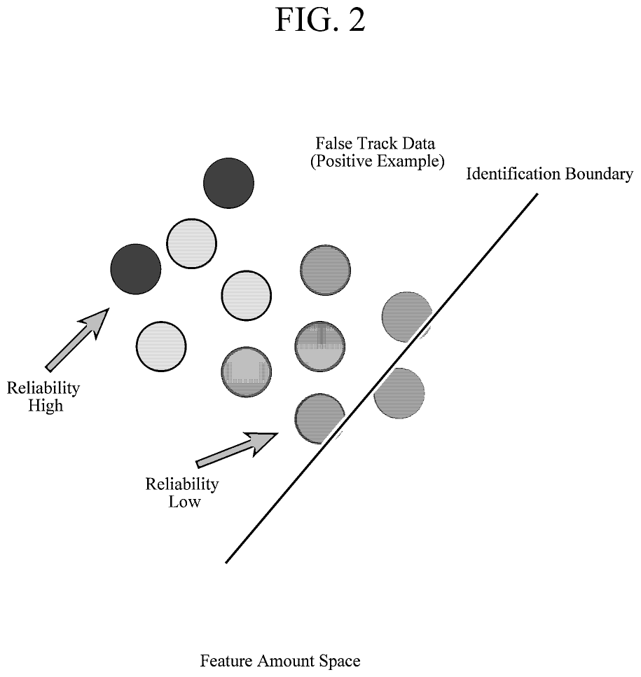

FIG. 2 is a diagram No. 2 illustrating a concept of binary classification performed by the binary classification device according to the present disclosure technology. Unlike the example illustrated in FIG. 1, in the example in FIG. 2, only samples of the group displayed as “false track data (positive example)” which is one of the two classes are depicted in a feature amount space.

As illustrated in FIG. 2, even in a case where only samples belonging to one of the two classes are given, there may be a situation in which an identification boundary needs to be obtained. In such a situation, there is a concept of obtaining the identification boundary by referring to the “reliability” for each sample. FIG. 2 illustrates a prediction principle that the identification boundary should be on the far side from the highly reliable sample.

Strictly speaking, the samples given are considered to belong to one class, and it is also conceivable that samples belonging to the other class are contained in the samples. In FIG. 2, this point is also represented by that, while most of the samples exist on the left side of the identification boundary, one sample with a low reliability exists on the right side of the identification boundary.

In learning such as machine learning, work of assigning a correct answer label to data is referred to as annotation. A person (human) or a device that performs the annotation is referred to as an annotator. The data becomes teacher data by the annotation.

It is conceivable that the “reliability” for the sample illustrated in FIG. 2 is determined subjectively by an annotator who is a human. Here, when the annotation is performed by a plurality of annotators, there is a problem that a bias is generated in the added reliability due to the individuality of the annotators. The term “bias” as used herein is used in the sense described in a dictionary, such as tendency, inclination, prejudice, and deviation of data or the like, and is not an electrical sense such as DC bias and bias voltage. The term “bias” does not mean a y-intercept derived from a direct current bias or the like.

In a situation where only a sample considered to belong to one of the two classes is given, the label may include a reliability added by the annotator in addition to the class to which the sample is considered to belong.

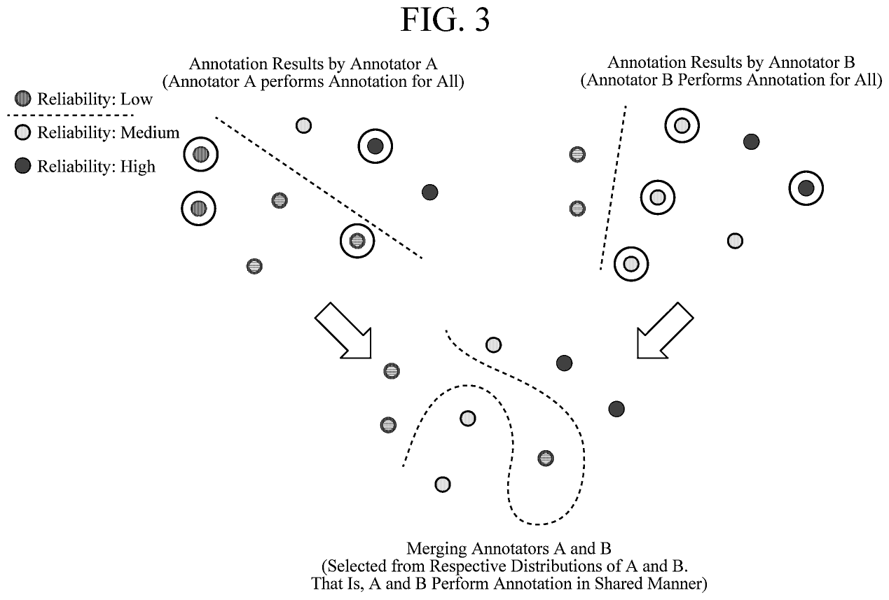

FIG. 3 is a diagram No. 3 illustrating a concept of binary classification performed by the binary classification device according to the present disclosure technology. Specifically, FIG. 3 illustrates a situation in which one data set including eight pieces of sample data is annotated by two annotators.

The upper left of FIG. 3 illustrates annotation results by one of the two annotators, annotator A. When a rule that a reliability is divided into three levels of high, medium, and low, and the identification boundary is provided between the reliabilities of medium and low is applied, the annotation by annotator A is constructed in such a manner that the identification boundary connects the upper left and the lower right.

The upper right of FIG. 3 illustrates annotation results by another one of the two annotators, annotator B. Similarly, when a rule that the identification boundary is provided between the reliabilities of medium and low is applied, in the annotation by annotator B, the identification boundary is on the left side of the whole, and is built in a substantially vertical direction with respect to the drawing.

A lower center of FIG. 3 illustrates a result of annotation performed by the annotator A and the annotator B in a shared manner. The samples shared by the annotator A are four samples surrounded by a circle in the upper left of FIG. 3. The samples shared by the annotator B are four samples surrounded by a circle in the upper right of FIG. 3. Similarly, when the rule that the identification boundary is provided between the reliabilities of medium and low is applied, in the annotation by sharing, the identification boundary can no longer be constructed with a linear line segment, and can be constructed only with a non-linear curve. Such a non-linear classification surface can only be created by relying on a solution by a non-linear support vector machine, for example.

Note that, among events in the world, in some cases, a correct answer label for a class to which samples belong is known, and as a result of attempting to perform classification in the feature amount space, classification can be implemented only in a non-linear classification plane. In such a case, for example, consideration is made to increase the number of dimensions of the feature amount. In a case where the number of dimensions of the feature amount cannot be increased more than the current state, for example, it is sufficient if a non-linear classification surface is obtained by referring to the solution by the non-linear support vector machine.

The present disclosure technology attempts to solve the problems illustrated in FIGS. 2 and 3 by modeling an individuality or a bias (hereinafter referred to as “bias or the like”) of each of the annotators and correcting the modeled bias or the like.

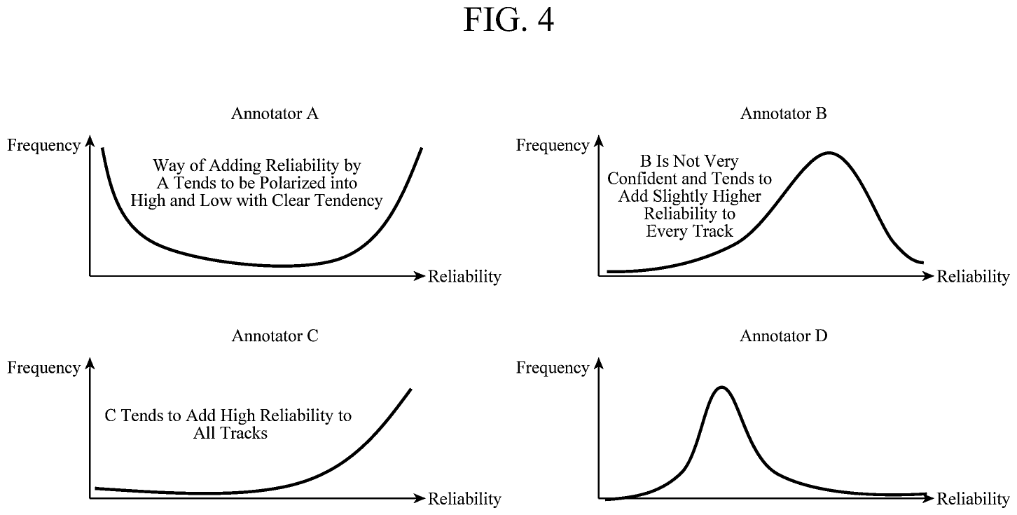

FIG. 4 illustrates an example in which biases and the like of annotators are modeled by a statistical distribution of reliability added by the annotators. Four graphs illustrated in FIG. 4 graphically illustrate biases of four annotators (annotator A, annotator B, annotator C, and annotator D). Specifically, the four graphs illustrated in FIG. 4 are histograms in which the horizontal axis indicates the degree of added reliability and the vertical axis indicates the frequency of addition. Note that, in the histogram, the horizontal axis is referred to as a grade (also referred to as an interval, a category, or a bin), and the vertical axis is referred to as a frequency.

The upper left graph of FIG. 4 is a histogram illustrating the bias of the annotator A. As illustrated in this histogram, it is possible to read the bias of the annotator A that has peaks of frequency of low and high in the way of adding reliability, and tends to be bipolar.

When the bias of a person having a nature of wanting to clarify black and white is represented by a graph, it can be expected that the characteristic is similar to the graph in the upper left of FIG. 4.

The upper right graph of FIG. 4 is a histogram illustrating the bias of the annotator B. As illustrated in the histogram, it is possible to read bias of the annotator B that has a gentle peak at a slightly higher position in the center and is close to a normal distribution in the way of adding reliability.

The lower left graph of FIG. 4 is a histogram illustrating the bias of the annotator C. As illustrated in the histogram, it can be read that the annotator C has a weight on the high side as a whole in the way of adding reliability, and the number of times of addition, which is a frequency, is the largest in the class with the highest reliability.

The lower right graph of FIG. 4 is a histogram illustrating the bias of the annotator D. The bias of the annotator D is different from those of the other annotators (A, B, and C). Thus, various biases of the annotator are conceivable.

### First Embodiment

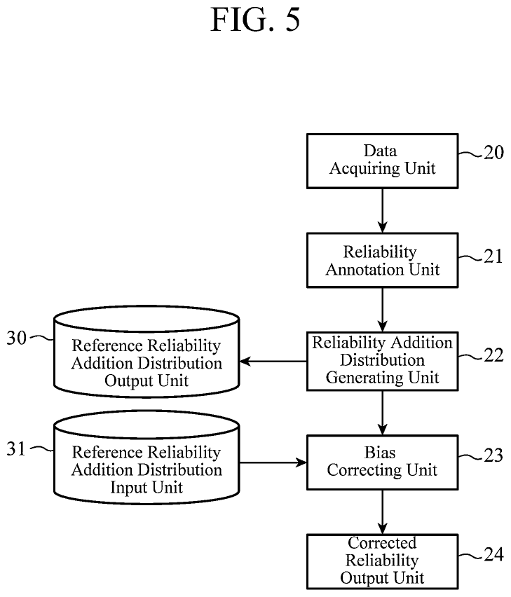

FIG. 5 is a block diagram illustrating a functional configuration of the binary classification device according to the first embodiment. As illustrated in FIG. 5, the binary classification device according to the first embodiment includes a data acquiring unit 20, a reliability annotation unit 21, a reliability addition distribution generating unit 22, a bias correcting unit 23, a corrected reliability output unit 24, a reference reliability addition distribution output unit 30, and a reference reliability addition distribution input unit 31.

### <<Data Acquiring Unit 20>>

The data acquiring unit 20 is a component for acquiring observation target data.

### <<Reliability Annotation Unit 21>>

The reliability annotation unit 21 is a component supporting the annotator to input, for each sample, reliability to the binary classification device, the reliability being subjectively considered by the annotator how likely the sample belongs to the target class.

For example, the reliability annotation unit 21 may perform processing of displaying a sample such as image data at a certain place on a display, and displaying a window for inputting the reliability considered by the annotator at another place on the display.

The reliability input by the annotator may be character information such as “high”, “medium”, or “low”, but needs to be scored in the end. In the present specification, the reliability is scored with a real number equal to or more than 0 and equal to or less than 1. The reliability annotation unit 21 may provide support in such a manner that the annotator can directly input a real number equal to or more than 0 and equal to or less than 1 as the reliability.

### <<Reliability Addition Distribution Generating Unit 22>>

The reliability addition distribution generating unit 22 is a component for calculating, for each annotator, a distribution of reliability added by the annotator (hereinafter referred to as “reliability addition distribution (p_{g})”). The reliability addition distribution (p_{g}) is displayed as a histogram, which is a reliability addition histogram (H_{g}). The reliability addition distribution generating unit 22 calculates the reliability addition histogram (H_{g}) of the reliability added by the annotator.

The bin width of the reliability addition histogram (H_{g}) may be appropriately determined depending on the purpose of use of the binary classification device.

### <<Bias Correcting Unit 23>>

The bias correcting unit 23 is a component for correcting the bias of the annotator by referring to a reference reliability addition distribution (pᵣ) to be described later. More specifically, the bias correcting unit 23 corrects the reliability addition histogram (H_{g}) to a corrected reliability addition histogram (H_{G}) having the same characteristic as the reference reliability addition distribution (pᵣ) by referring to the reference reliability addition distribution (pᵣ).

Here, as the reference reliability addition distribution (pᵣ), it is desirable to use a reliability addition distribution generated from a distribution (hereinafter referred to as “addition distribution”) of results of addition by an annotator with a high proficiency level. In other words, the reference reliability addition distribution (pᵣ) is desirably an addition distribution of the reliability added by a person selected by referring to the proficiency level among annotators.

The reference reliability addition distribution (pᵣ) may be a continuous probability distribution such as a beta distribution. Note that the subscript r in Pᵣ representing the reference reliability addition distribution (pᵣ) is derived from the initial letter of the English word “reference” meaning a reference.

The present disclosure technology is similar to the concept of adjusting a scoring gap, for example, by standard deviation employed in essay-based examinations of national qualification examinations, in that it uses statistical indicators to eliminate the bias of the annotator or the scoring person. However, employing the reliability addition distribution generated by results of addition by the annotator with a high proficiency level as the reference reliability addition distribution (pᵣ) is a technique unique to the present disclosure technology.

### <<Corrected Reliability Output Unit 24>>

The corrected reliability output unit 24 is a component that corrects a reliability input by the annotator by referring to a correction result of the bias correcting unit 23 and outputs the corrected reliability. The reliability is corrected by referring to a corrected reliability addition histogram (H_{G}) to be described later.

### <<Reference Reliability Addition Distribution Output Unit 30>>

The reference reliability addition distribution output unit 30 is a component for outputting the reference reliability addition distribution (pᵣ) to an external storage device.

### <<Reference Reliability Addition Distribution Input Unit 31>>

The reference reliability addition distribution input unit 31 is a component for acquiring, from an external storage device, the reference reliability addition distribution (pᵣ) stored in the external storage device.

Note that the reference reliability addition distribution output unit 30 and the reference reliability addition distribution input unit 31 may function as a storage device. The reference reliability addition distribution output unit 30 and the reference reliability addition distribution input unit 31 themselves may store the reference reliability addition distribution (pr).

### Operation of Binary Classification Device According to First Embodiment

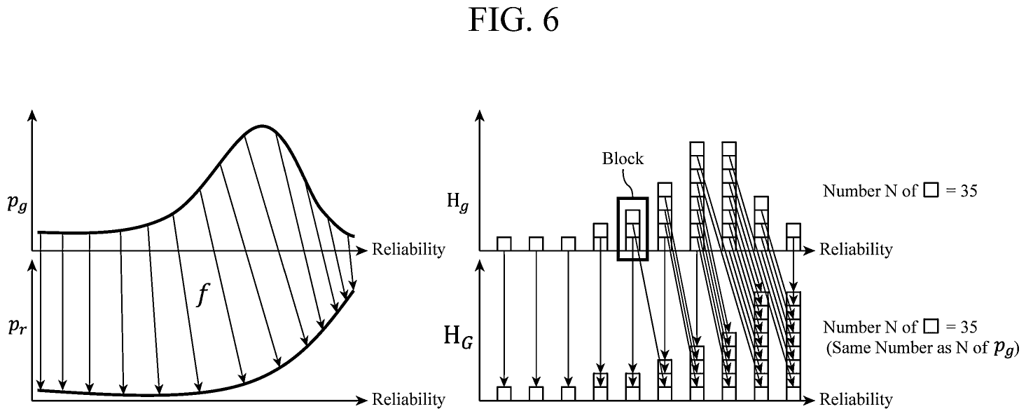

FIG. 6 is a diagram illustrating a state in which the bias of the annotator is corrected by referring to the reference reliability addition distribution (pᵣ).

The upper left graph of FIG. 6 represents the reliability addition distribution (p_{g}) of the annotator to be corrected. The reliability addition distribution (p_{g}) represents the bias of the annotator. The lower left graph of FIG. 6 represents the reference reliability addition distribution (pᵣ). What is imposed on the present disclosure technology is to obtain a mapping (f) from the upper left graph to the lower left graph.

The two graphs illustrated on the right side of FIG. 6 represent graphs of the two distributions illustrated on the left side of FIG. 6 as histograms. In the present specification, the histogram in the upper right of FIG. 6 is referred to as a reliability addition histogram (H_{g}). The lower right histogram of FIG. 6 is referred to as a corrected reliability addition histogram (H_{G}).

The two graphs illustrated on the right side of FIG. 6 indicate that the same samples can be associated even between different distributions assuming that “the order of samples when the samples are arranged in the order of added reliabilities does not change by any annotator”. The right side of FIG. 6 also illustrates processing contents in which the samples in the upper right histogram of FIG. 6 are arranged in the lower right histogram of FIG. 6 in order of reliability.

By referring to the assumption that “the order when the samples are arranged in the order of added reliabilities does not change by any annotator”, a mapping (f) between any distributions can also be obtained.

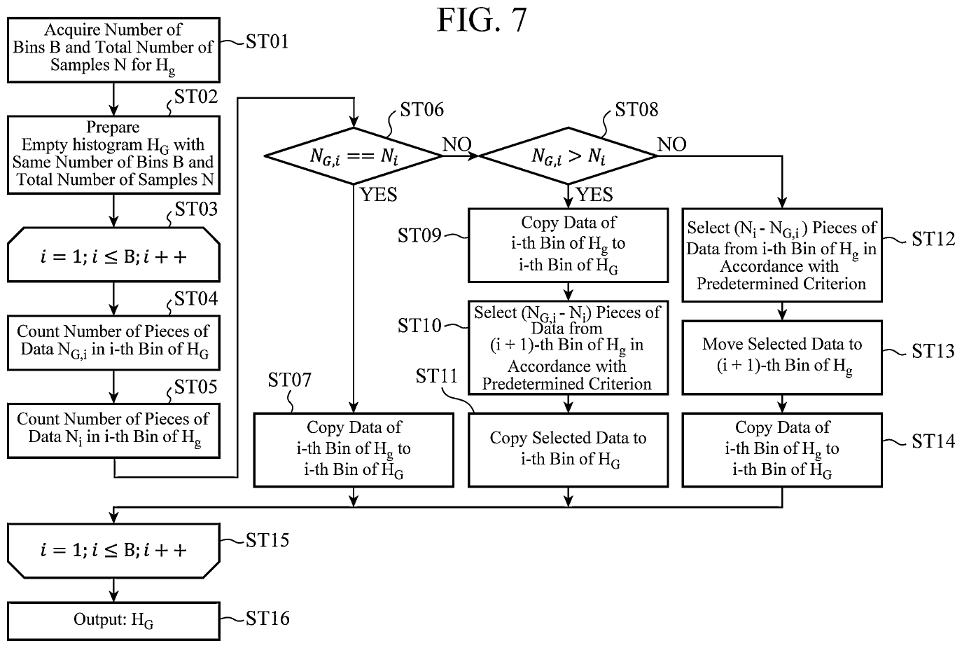

Even when the order when the samples are arranged in the order of reliabilities added by the annotator changes, it is possible to formally correct the bias of the annotator. In the corrected reliability addition histogram (H_{G}) in the lower right of FIG. 6, information of samples is emptied as an initial state, and the information of samples can be associated in the order of the reliabilities added by the annotator. Details of the association will be apparent from the following description with reference to FIG. 7.

FIG. 7 is a flowchart illustrating processing steps of the binary classification device according to the first embodiment. Specifically, FIG. 7 illustrates a processing step of the bias correcting unit 23 that generates the corrected reliability addition histogram (H_{G}) illustrated in the lower right part of FIG. 6 from the reliability addition histogram (H_{g}) of the annotator illustrated in the upper right part of FIG. 6 by referring to the reference reliability addition distribution (pᵣ).

In a first step ST01, the bias correcting unit 23 checks the number of bins (B) and the total number of samples (N) for the reliability addition histogram (H_{g}) of the annotator to be corrected. In the histogram illustrated in the upper right of FIG. 6, B of the number of bins is 10, and N of the total number of samples is 35.

In a second step ST02, the bias correcting unit 23 prepares a histogram (hereinafter referred to as a “corrected reliability addition histogram (H_{G})”) having the same number of bins (B, 10 in the example of FIG. 6) and the same total number of samples (N, 35 in the example of FIG. 6) as those of the reliability addition histogram (H_{g}) of the annotator to be corrected and having the same characteristics as those of the reference reliability addition distribution (pᵣ) by referring to the reference reliability addition distribution (pᵣ). In the stage of the second step ST02, the corrected reliability addition histogram (H_{G}) has not been associated with samples yet. In other words, in the corrected reliability addition histogram (H_{G}) at the stage of the second step ST02, the information of samples is empty. In the present specification, a histogram in which the information of samples is empty is referred to as an “empty histogram” as illustrated in FIG. 7. Further, in the histogram, a bin in which the information of samples is empty is referred to as an “empty bin”.

In a third step ST03, the bias correcting unit 23 starts a loop of a For statement. The number of loops of the For statement is the same as the number of bins (B) checked in the first step ST01. In the case of the histogram illustrated in the upper right of FIG. 6, the number of loops of the For sentence is 10. A counter variable of the For statement is assumed to be i.

In a fourth step ST04, the bias correcting unit 23 counts the number of samples (N_{G,i}) in the ith bin of the corrected reliability addition histogram (H_{G}).

In a fifth step ST05, the bias correcting unit 23 counts the number of samples (Nᵢ) in the ith bin of the reliability addition histogram (H_{g}).

Note that the order of the fourth step ST04 and the fifth step ST05 may be interchanged.

A sixth step ST06 and an eighth step ST08 are processing steps for conditionally branching the flow by referring to the magnitude relationship between the number of samples (N_{G,i}) in the ith bin of the corrected reliability addition histogram (H_{G}) and the number of samples (Nᵢ) in the ith bin of the reliability addition histogram (H_{g}). The sixth step ST06 and the eighth step ST08 may be an If statement or a Switch statement.

When N_{G,i} is equal to Nᵢ, the processing flow proceeds to a seventh step ST07.

In a case where N_{G,i} is larger than Nᵢ, the processing flow proceeds to a ninth step ST09, a 10th step ST10, and an 11th step ST11.

In a case where N_{G,i} is smaller than Nᵢ, the processing flow proceeds to a 12th step ST12, a 13th step ST13, and a 14th step ST14.

In a case where N_{G,i} and Nᵢ are equal, in the seventh step ST07, the bias correcting unit 23 associates the sample of the ith bin of the reliability addition histogram (H_{g}) with the ith bin (the state of the empty bin) of the corrected reliability addition histogram (H_{G}). In the present specification, the process of associating the information of samples with an empty histogram or an empty bin is referred to as “copy”.

In a case where N_{G,i} is larger than Nᵢ, in the ninth step ST09, the bias correcting unit 23 copies the sample of the ith bin of the reliability addition histogram (H_{g}) to the ith bin (the state of the empty bin) of the corrected reliability addition histogram (H_{G}).

In the 10th step ST10, the bias correcting unit 23 selects samples by the number obtained by subtracting Nᵢ from N_{G,i} from the (i+1)-th bin of the reliability addition histogram (H_{g}). A criterion for selecting the samples only needs to be in accordance with the order of the samples arranged in the order of the reliabilities added by the annotator. In a case where the annotator cannot rank the samples, it is sufficient if a rule based on plot positions of samples in the feature amount space, such as the order of distances from centroids of all samples in the feature amount space, is determined as the criterion for selecting the samples.

In the 11th step ST11, the bias correcting unit 23 copies the sample selected in the 10th step ST10 to a portion remaining to be empty in the ith bin of the corrected reliability addition histogram (H_{G}).

In a case where N_{G,i} is smaller than Nᵢ, in the 12th step ST12, the bias correcting unit 23 selects samples by the number obtained by subtracting N_{G,i} from Nᵢ from the ith bin of the reliability addition histogram (H_{g}). A criterion for selecting the samples may be the same as that in the 10th step ST10.

In the 13th step ST13, the bias correcting unit 23 temporarily associates the sample selected in the 12th step ST12 with the (i+1)-th bin of the reliability addition histogram (H_{g}). In the present specification, processing of associating a sample of a certain bin with another bin in one histogram is referred to as “movement”.

In the 14th step ST14, the bias correcting unit 23 copies the sample of the ith bin of the reliability addition histogram (H_{g}) to the ith bin (the state of the empty bin) of the corrected reliability addition histogram (H_{G}).

After completion of the seventh step ST07, the 11th step ST11, or the 14th step ST14, the processing step proceeds to a 15th step ST15.

In the 15th step ST15, the bias correcting unit 23 increments the counter variable (i) of the For statement, and repeats the processing of the For statement until the end condition of the For statement is satisfied, that is, until i becomes the same as B. When the end condition of the For statement is satisfied, the processing step proceeds to a 16th step ST16.

In the 16th step ST16, the bias correcting unit 23 outputs the corrected reliability addition histogram (H_{G}) in which the association of the information of samples is completed.

### Hardware Configuration of Binary Classification Device According to First Embodiment

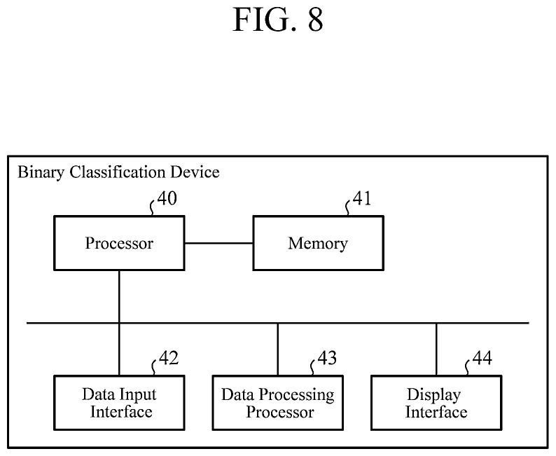

FIG. 8 is a block diagram illustrating a hardware configuration of the binary classification device according to the first embodiment. As illustrated in FIG. 8, hardware of the binary classification device includes a processor 40, a memory 41, a data input interface 42, a data processing processor 43, and a display interface 44.

Note that, in the hardware configuration illustrated in FIG. 8, a configuration including two processors of the processor 40 that controls the overall processing and the data processing processor 43 specialized for data processing is illustrated, but this is an example, and the present disclosure technology is not limited thereto. In the binary classification device according to the present disclosure technology, each function may be implemented by one processor.

Each of the functions of the data acquiring unit 20, the reliability addition distribution generating unit 22, the bias correcting unit 23, the corrected reliability output unit 24, the reference reliability addition distribution output unit 30, and the reference reliability addition distribution input unit 31 in the binary classification device is implemented by a processing circuit. That is, the binary classification device includes a processing circuit for performing the processing steps illustrated in FIG. 7 and the like. The processing circuit is the processor 40 (also referred to as a CPU, a central processing unit, a processing device, an arithmetic device, a microprocessor, a microcomputer, or a DSP) that executes a program stored in the memory 41.

Each of the functions of the data acquiring unit 20, the reliability addition distribution generating unit 22, the bias correcting unit 23, the corrected reliability output unit 24, the reference reliability addition distribution output unit 30, and the reference reliability addition distribution input unit 31 is implemented by software, firmware, or a combination of software and firmware. Software and firmware are described as programs and stored in the memory 41. The processing circuit implements the functions of the respective units by reading and executing programs stored in the memory 41. That is, the binary classification device includes the memory 41 for storing a program that results in execution of the processing steps illustrated in FIG. 7 and the like when executed by the processing circuit. Further, it can also be said that these programs cause a computer to execute the procedures or methods performed in the data acquiring unit 20, the reliability addition distribution generating unit 22, the bias correcting unit 23, the corrected reliability output unit 24, the reference reliability addition distribution output unit 30, and the reference reliability addition distribution input unit 31. Here, the memory 41 may be a nonvolatile or volatile semiconductor memory such as RAM, ROM, a flash memory, EPROM, or EEPROM. Further, the memory 41 may include a disk such as a magnetic disk, a flexible disk, an optical disk, a compact disk, a mini disk, or a DVD. Furthermore, the memory 41 may be in the form of an HDD or an SSD.

The data processing processor 43 in the binary classification device includes artificial intelligence including a mathematical model such as an artificial neural network. The artificial intelligence performs learning with a training data set labeled by referring to the corrected reliability output from the corrected reliability output unit 24.

As described above, since the binary classification device according to the first embodiment has the above configuration, learning can be performed by referring to the training data set in which the bias of the annotator is corrected.

### Second Embodiment

A binary classification device according to a second embodiment is a modification of the binary classification device according to the present disclosure technology. Unless otherwise specified, the same reference numerals as those used in the first embodiment are used in the second embodiment. In the second embodiment, the description overlapping with the first embodiment is appropriately omitted.

As described above, the binary classification device according to the present disclosure technology can be used in a scene where an event that is difficult to objectively score and is scored by a plurality of scoring persons is learned by artificial intelligence and scored. In particular, the present disclosure technology can be used when generating a training data set necessary for learning of artificial intelligence.

In the terms described in the first embodiment, the annotator may be read as “scoring person”, and the reliability may be read as “score”.

The present disclosure technology can be applied to a scene where an event that is scored by a plurality of scoring persons, for example, an essay-based examination response is scored by artificial intelligence. Further, the present disclosure technology can also be applied to a scene where an event that is difficult to objectively score, for example, an artistic work such as literature, music, or painting, is scored by artificial intelligence.

The bias correcting unit 23 according to the second embodiment calculates and outputs the following index (Tᵢ) together with the corrected reliability addition histogram (H_{G}).

$$for i = 1 to N \qquad ( 1 )$$

$${T}_{i} = \{ \begin{matrix}α \frac{{x}_{i} - {μ}_{x}}{{σ}_{x}} + β , & if {α}_{x} \neq 0 \\ β , & if {σ}_{x} = 0\end{matrix}$$

Here, μₓ represents an average value of scoring performed by a scoring person A, and σₓ represents a standard deviation of scoring performed by the scoring person A. Further, xᵢ is a score added by the scoring person A for the ith sample to be scored. Furthermore, α is a parameter related to the weight of the score, and β is a numerical value representing a half of the full score. When α is 10 and β is 50, the index (Tᵢ) is equal to the deviation value.

μₓ and σₓ can be expressed by the following mathematical expressions.

$${μ}_{x} = \frac{1}{N} {\sum }_{i = 1}^{N} {x}_{i} \qquad ( 2 )$$

$${σ}_{x} = \sqrt{\frac{1}{N} {\sum }_{i = 1}^{N} {( {x}_{i} - {μ}_{x} )}^{2}} \qquad ( 3 )$$

It can be said that the index (Tᵢ) is a score adjusted by the standard deviation. That is, the bias correcting unit 23 according to the second embodiment outputs the score (Tᵢ) adjusted by the standard deviation together with the corrected reliability addition histogram (H_{G}).

By comparing the index (Tᵢ) output by the bias correcting unit 23 with the corrected reliability output by the corrected reliability output unit 24, it is possible to check the reference reliability addition distribution (pᵣ) characteristics.

As described above, since the binary classification device according to the second embodiment performs the above processing, it is possible to perform learning by referring to the training data set in which the bias of the scoring person is corrected while checking the reference reliability addition distribution (pᵣ) characteristic.

### INDUSTRIAL APPLICABILITY

The present disclosure technology can be applied to, for example, automation of work of dropping and deleting a position of a false track in a PPI scope of a radar, and has industrial applicability.

### REFERENCE SIGNS LIST

20: data acquiring unit, 21: reliability annotation unit, 22: reliability addition distribution generating unit (reliability addition distribution generator), 23: bias correcting unit (bias corrector), 24: corrected reliability output unit (corrected reliability output), 30: reference reliability addition distribution output unit, 31: reference reliability addition distribution input unit, 40: processor, 41: memory, 42: data input interface, 43: data processing processor, 44: display interface

What is claimed is:

1. A binary classification device, comprising:
a reliability addition distribution generator to calculate, for each of annotators, a reliability addition histogram regarding a reliability added to a sample by the annotator;
a bias corrector to correct, by referring to a reference reliability addition distribution, the reliability addition histogram to a corrected reliability addition histogram having a same characteristic as a characteristic of the reference reliability addition distribution; and
a corrected reliability output to correct the reliability added by the annotator by referring to the corrected reliability addition histogram.

2. The binary classification device according to claim 1, wherein
the reference reliability addition distribution is an addition distribution of the reliability added by a person selected by referring to a proficiency level among the annotators.

3. The binary classification device according to claim 1, wherein
the bias corrector outputs a score adjusted by a standard deviation together with the corrected reliability addition histogram.

4. A method for correcting annotation in a binary classification device, the method comprising, by a processing circuit:
calculating, for each of annotators, a reliability addition histogram regarding a reliability added by the annotator;
correcting, by referring to a reference reliability addition distribution, the reliability addition histogram to a corrected reliability addition histogram having a same characteristic as a characteristic of the reference reliability addition distribution; and
correcting the reliability added by the annotator by referring to the corrected reliability addition histogram.

5. The annotation correction method of a binary classification device according to claim 4, wherein
the reference reliability addition distribution is an addition distribution of the reliability added by a person selected by referring to a proficiency level among the annotators.

6. The annotation correction method of a binary classification device according to claim 4, wherein
the processing circuit outputs a score adjusted by a standard deviation together with the corrected reliability addition histogram.
